(19) United States
(12) Patent Application Publication
(10) Pub. No.: US 2008/0185926 A1
(43) Pub. Date: Aug. 7, 2008

(54) Self-Disengaging Fan For an Elecromagnetic Retarder

(75) Inventors: Bruno Dessirier, Saint Germain en Laye (FR); Stephane Hailly, Issy les Moulineaux (FR)

Correspondence Address: MATTHEW R. JENKINS, ESQ., 2310 FAR HILLS BUILDING, DAYTON, OH, 45419, US

(73) Assignee: TELMA, Saint-Ouen-L'Aumone (FR)

(21) Appl. No.: 11/912,453

(22) PCT Filed: Apr. 19, 2006
(86) PCT No.: PCT/FR2006/000858

§ 371 Date: Oct. 24, 2007

(30) Foreign Application Priority Data
Apr. 29, 2005 (FR) 0504402

(51) Int. Cl. H02K 9/04; H02K 49/04

(52) U.S. Cl. 310/63

(57) ABSTRACT

The invention relates to a self-disengaging embodiment for a fan in an electromagnetic retarder. The retarder comprises a rotating shaft, a rotor rotationally fixed to the rotating shaft, induction coils, arranged in a crown on the rotor, a generator with a rotor mounted on one end of the rotating shaft and supplying the induction coils and a fan to circulate a cooling gas around the induction coils. The fan is fitted to freely rotate about the rotating shaft and is provided with means forming an armature which may be exposed to an electromagnetic field created by the induction coils and causing the fan to rotate.

The present invention concerns a disengageable arrangement of a fan in an electromagnetic retarder, and an electromagnetic retarder comprising a rotating shaft with a fan mounted on the rotating shaft according to this arrangement.

### FIELD OF THE INVENTION

The present invention concerns an electromagnetic retarder comprising means for creating a flow of a gaseous fluid, typically a flow of air, for cooling induction coils disposed in a ring on a rotor of the retarder and inside a stator that surrounds the rotor and is intended to be mounted on a chassis of the vehicle.

Electromagnetic retarders often have fans for cooling components that heat up, such as coils or electronic circuits. These fans are generally attached to a shaft of the retarder. Thus, when the retarder starts to operate, these fans create a flow of air that flows towards the coils of the retarder in order to cool them. This cooling prevents a fall-off in performance of the retarder when hot. Overall, a fan helps to create up to ten percent of the total braking torque generated by the retarder.

However, the use of such fans has limits.

This is because, as the shaft of the retarder rotor is connected to the output shaft of the gearbox or to the input shaft of the rear axle of a motor vehicle, the shaft of the rotor turns continuously. The driving of the fan therefore causes a not insignificant consumption of mechanical power, even when the retarder is not in operation. In other words, even when the retarder is not activated, the fan consumes unnecessary mechanical torque, which therefore results in an unnecessary consumption of diesel.

Thus, when the retarder is not functioning, ventilation losses due to the driving of the fan, also referred to as off-load losses, can be observed. These losses, which decrease the speed output of the vehicle, increase by a power of three the speed of rotation of the rotor shaft. In addition, the fans make noise.

For these reasons, the manufacturers of so-called heavy vehicles such as lorries, coaches and buses and special vehicles such as those for rubbish collection, are more and more often indicating in a specification a maximum off-load loss to be observed when the retarder is not functioning. These losses must be very much less than the losses caused by the fan when the retarder is in operation. In addition, the noise from the fan in the phases of non-use of the retarder must not exceed a predetermined level.

To mitigate the various drawbacks stated above, certain retarders have been equipped with disengageable fans. Thus tests have been carried out with electromagnetic clutches of the coil or powder type. Other tests are being carried out with fans with viscostatic disengagement or hydraulic control.

However, the use of such clutches poses a problem because of the electrical or hydraulic supply that must be installed, in whatever way, on the rotating shaft of the retarder. It is therefore necessary to take into account the wear on the rotating contacts or rotating seals, according to the type of clutch chosen, and the problems of functioning and control of the clutch as well as the additional need to maintain the vehicle that result therefrom. In addition, it was found on each occasion that the system chosen was bulky and gave rise to a more or less great additional weight, according to the system chosen. In addition, the retarders equipped with such fans showed themselves to be limited in terms of resistance to temperature, in particular when it was a case of high-speed retarders.

### BACKGROUND OF THE INVENTION

The aim of the invention is to mitigate the various drawbacks stated above.

More particularly, the invention must propose a solution that if possible affords a robust, simple and compact system in order to be able to house it inside the retarder or, at least, so that it does not contribute to an increase in the size of the retarder.

At the very least, the invention must propose a solution for resolving the problem of excessively great off-load losses. In other words, the invention must facilitate the cooling of the coils, whilst limiting the consumption of a torque on the shaft, in particular during the periods of non-use of the retarder.

### SUMMARY OF THE INVENTION

The aim of the invention is achieved with a disengageable arrangement of a fan in an electromagnetic retarder, the retarder comprising a rotating shaft, a rotor rotationally fixed to the rotating shaft, induction coils disposed in a ring on the rotor, a generator with a rotor mounted on one end of the rotating shaft and supplying the induction coils and a fan for circulating a cooling gaseous fluid on the induction coils.

According to the arrangement of the invention, the fan is mounted so as to rotate freely on the rotating shaft of the retarder and is provided with means forming an armature able to be exposed to an electromagnetic field generated by the induction coils and driving the fan in rotation.

The invention therefore uses a fan that can be disengaged from its drive.

This fan is a rotary fan mounted on the shaft of the rotor so as to be free to rotate with respect to the shaft whenever the retarder is not being acted on or activated, that is to say whenever it is not functioning. In order to obtain this freedom in rotation, the fan is mounted, according to one or other of several possible embodiments of the invention, on a ball bearing, on a roller bearing, on a sliding bearing or on any other type of bearing allowing a relative rotation movement between the fan and the rotating shaft without suffering friction effects, for example shoes. The fan can also be produced from plastics material with a low coefficient of friction compared with steel and be mounted on the rotating shaft without a bearing.

According to the various possible embodiments of the invention, the fan comprises a ring made from electromagnetic steel, when its blades are produced from a non-magnetic material such as a synthetic material or aluminium, or the fan comprises blades conformed, at least in a part opposite the induction coils, so as to be exposed sufficiently to the magnetic field of the induction coils, when at least these parts of the blades are produced from an electromagnetic material such as soft steel. The blades can also comprise a permanent magnet.

In one example embodiment, the fan is positioned alongside the retarder rotor so that the heads of the coils of the inducing rotor are opposite the ring of the fan. These coils and this ring are then in mutual influence and, when the coils of the inducing rotor are supplied, this allows the driving of the fan by the creation of a torque.

More precisely, when the retarder is not functioning, the coils of the inducing rotor of the retarder are not supplied. Thus there is no creation of magnetic field. Since the electromagnetic ring fixed to the fan is therefore not in this magnetic field, driving of the fan does not occur and the fan then behaves freely on the shaft of the rotor on which it is mounted by means of a bearing.

On the other hand, when the retarder is functioning, the supply to the coils of the inducing rotor creates a magnetic field, which passes directly into the armature, which is a source of eddy currents but which loops back onto itself, passing through the metal ring of the fan in mutual influence.

This device makes it possible to engage the fan according to the principle of asynchronous machines. The engagement of the fan then makes it possible to ensure cooling of the coils of the inducing rotor and consequently to improve the functioning of the retarder.

In such a configuration, it is only when the retarder is in operation that the fan consumes a torque from the shaft. This torque is added to and participates in the braking of the vehicle.

However, the speed of rotation of the fan being less than that of the rotating shaft, because of the functioning according to the principle of asynchronous machines, it is possible to mitigate this drawback, at least partially, by forming the metallic ring according to the squirrel cage principle as in asynchronous machines (ring made from stacked insulated soft steel sheets, held between two aluminium plates and connected by means of aluminium bars).

The invention thus makes it possible to increase the performance of the retarder through a better control of the cooling of the coils but also good control of the consumption of diesel by the vehicle outside the use of the retarder, that is to say approximately 85% of its time.

In order to increase efficiency even further, the heads of the induction coils of the rotor can be provided, at their centre, with a pole made from magnetic material. This pole is not necessarily, but preferably, fixed to the support of the coil head, for example by a screw. By virtue of the presence of magnetic poles, the induction of the coils is increased.

The solution that the invention proposes is simple to integrate into the design of a retarder, is not bulky and is lightweight and very economical since there are only two components to be added, namely a bearing and a ring of soft steel or equivalent means.

In addition, the solution of the invention does not require any control means. This is because the fan is self-contained in its switching on since it is actuated at the same time as the excitation of the induction coils.

The fan used in the invention can be of the axial, centrifugal or helico-centrifugal type. Such a fan is produced according to a given application for which a given air flow is necessary for cooling coils of the retarder placed in a particular configuration.

In a particular embodiment, the fan comprises a support inside which permanent magnets are fitted instead of the electromagnetic ring.

In a variant, the ring can be produced from a lamination of insulated metal sheets provided with conductors in short-circuit, the principle of asynchronous cage machines. The invention also concerns the following characteristics considered in isolation or according to any technically possible combination:

the fan is produced from a non-magnetic material;

the ring forming an armature is produced in the form of a permanent magnet;

the means forming an armature comprise blade parts conformed so as to pass in front of the induction coil so as to be able to be sufficiently induced by the magnetic field of the induction coils for the fan to be driven in rotation;

the fan is produced from an electromagnetic material;

the fan is mounted on the rotating shaft by means of a bearing;

the fan is mounted on the rotating shaft by means of a sliding bearing.

The aim of the invention is also achieved with an electromagnetic retarder comprising a rotating shaft with a fan in order to circulate a cooling gaseous fluid on induction coils intended to generate, on command, eddy currents in a stator surrounding the rotating shaft and the induction coils.

According to the invention, the fan is mounted so as to rotate freely on the rotating shaft and is provided with means forming an armature able to be exposed to an electromagnetic field generated by the induction coils and driving the fan in rotation.

### BRIEF DESCRIPTION OF THE DRAWINGS

Other characteristics and advantages of the present invention will emerge from the following description of an embodiment of the invention, this description being given with reference to the accompanying drawings, in which:

FIG. 1 shows a retarder according to the invention comprising several disengageable fans mounted on a rotating shaft of the retarder fixed to an output shaft of a gearbox, and

FIG. 2 shows a disengageable fan mounted on a bearing, comprising a cylindrical cage and rotating about a shaft comprising coils.

These figures are given by way of illustration and are not limitative of the invention.

### DESCRIPTION OF THE PREFERRED EMBODIMENTS

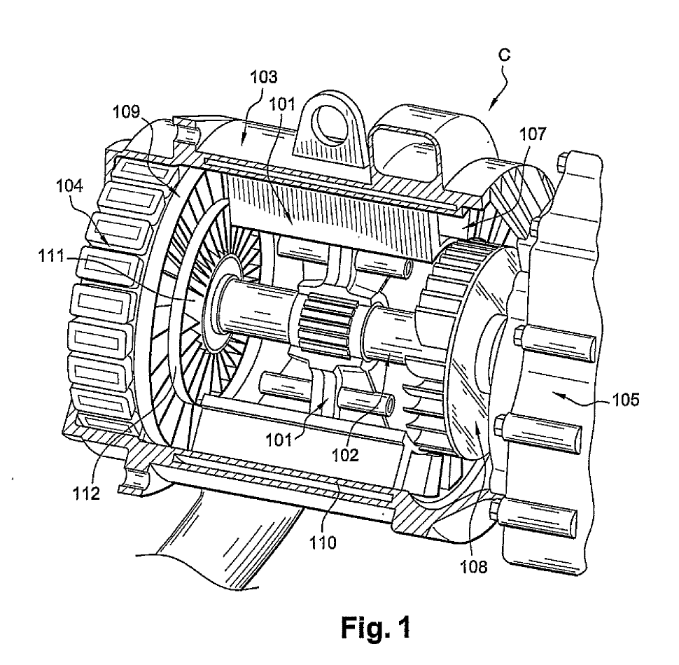

FIG. 1 gives the general structure of an electromagnetic retarder and shows at the same time the arrangement of a disengageable fan 109 mounted on a rotating shaft of the retarder. The retarder also comprises a second fan 108, not disengageable, which can however be replaced by a second disengageable fan according to the invention.

The electromagnetic retarder is shown in a view in perspective with partial axial cutaway and as being mounted on a gearbox 105 of a motor vehicle in the heavy category. This retarder, which is intended to retard a transmission shaft of the vehicle and more particularly here the output shaft of the gearbox 105, by generating a magnetic field with alternating distribution in a ferromagnetic piece, comprises a cooling jacket C in a helical shape in a single turn.

The retarder comprises a rotating shaft 102 attached to the output shaft of the gearbox 105 and an inducing rotor 101 rotationally integral with the rotating shaft 102. Induction coils 107 of the rotor are disposed in a ring on the rotor 101 and inside a stator comprising an armature 110 surrounding the rotor 101. The armature 110 forms together with an envelope 103 the cooling water jacket C intended to be mounted on a chassis of the vehicle. The retarder also comprises a generator having a generating rotor 106, fixed to the rotating shaft 102 and thus to the inducing rotor 101, and coils 104, as well as the fan 109 for circulation a gaseous cooling fluid, generally air, over the induction coils 107 of the rotor 101.

The ring of coils 104 surrounds the generating rotor with a small air gap.

The coils 104 are supplied by a direct current source such as a battery of the vehicle equipped with the starter. The intensity of this current is governed according to the braking torque that the retarder must produce. This is because, by adjusting the intensity of the induction current of the coils 104, there are adjusted the intensity of the electric current generated by the generator and, by this finally, the intensity of the eddy currents giving rise to braking and heating, generated in the armature 110 of the water jacket C.

The generation of the electrical supply current necessary for generating the eddy currents, by a generator integrated in the retarder, affords a dual advantage. The first advantage consists of a very small supply of electrical energy taken from the vehicle battery, for example around 20% to 30% of the total energy necessary. The second advantage is that the generation of electric current by the generator itself consumes a certain amount of mechanical energy taken from the shaft to be retarded.

The excitation current generated by the generator supplies the induction coils 107 of the rotor 101 of the retarder in order to generate an alternating magnetic field. The coils 107 are formed by windings of electric wires around cores forming integral parts of the rotor 101. The alternating magnetic field induces the armature 110 of the retarder and generates eddy currents therein, produced in a ferromagnetic material. The eddy currents being opposed, by their effects, to the cause that gives them the direction, namely the rotation movement of the rotor, the rotation movement of the rotor 101 thus generates a reverse rotation torque, and therefore a braking torque.

The generation of the eddy currents being accompanied by heating, by Joule effect, in particular of the armature 110, this part is cooled with a cooling liquid, for example water, circulating in the cooling jacket C in which the armature 110 is advantageously integrated.

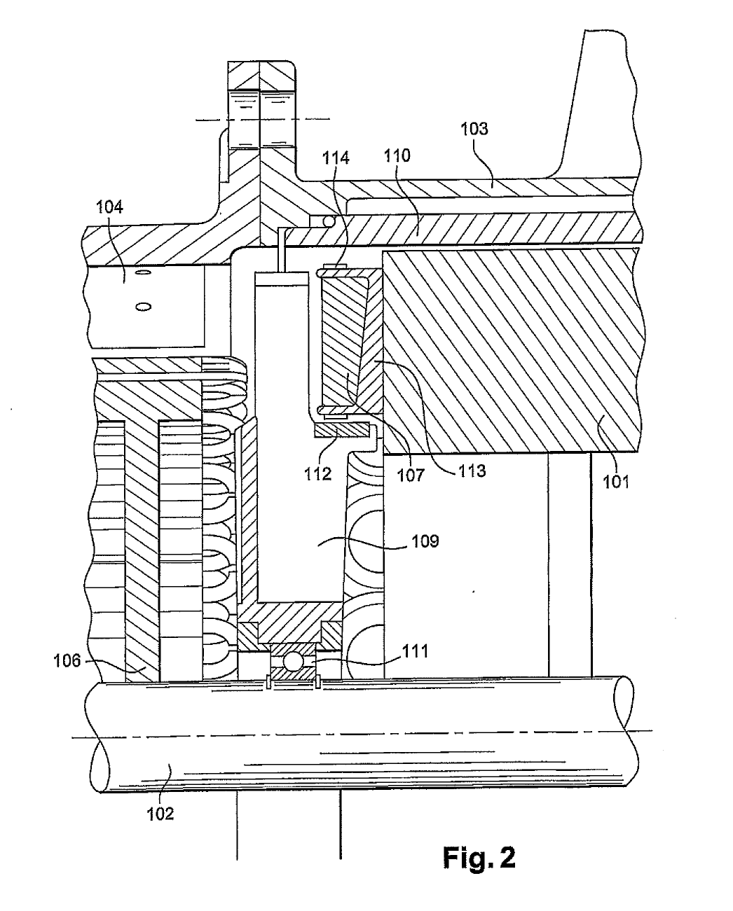

FIG. 2 shows, in the form of an axial section, that the fan 109 is mounted on a bearing 111 and also comprises an annular engagement system 112.

The bearing 111, in order to offer the fan 109 its degree of freedom in rotation, can be either of the ball or roller type or be replaced by any other system offering a possibility of relative rotation.

The engagement system 112 is formed essentially by a ring made from a magnetisable material such as soft steel and makes it possible to engage the fan 109 simultaneously with the actuation of the retarder by supplying the coils 107 of the inducing rotor. The rotary fan 109 and the engagement ring 112 made from magnetic material are fixed to each other.

When the retarder is in operation, supplying the coils 107 with current allows the creation of a magnetic field. The magnetic looping with the annular system 112 of the fan 109 makes it possible to drive the latter in rotation. This effect can be augmented by placing in the ends of the coils, held by supports 113 fixed to the rotor 101, poles 114 passing through the corresponding coils.

When the retarder is not in operation, there is no magnetic field and therefore no coupling with the engagement system 112. The bearing 111 then enables the fan 109 to be free to rotate with respect to the rotating shaft 102, that is to say the axis of the rotor 101. In other words, when the retarder is not functioning, the bearing 111 enables the fan 109 to have a degree of freedom in rotation with respect to the axis 102.

Quantities are linked to the current created by the coils of the generator in order to supply the coils of the rotor and generator braking torque. This is because, the higher this current, the greater the electromagnetic field generated by the coils 107 of the inducing rotor 101. Thus, the higher this current, the more intense a magnetic coupling between the annular system 112 and the inducing rotor 101 fixed to the rotating shaft 102. And the more intense this coupling, the more the fan 109 rotates at a high speed close to the speed of rotation of the shaft 102, cooling the coils 107 of the rotor 101 in an optimum manner. The current level is directly related to the control of the retarder. This is because the fan engagement control corresponds to the creation of a magnetic field through the coils 107.

In this configuration of a system of engagement of the fan 109 mounted on a bearing 111, the particularity is that, when the retarder function stops, the fan for a certain amount of time continues to rotate and therefore to cool the coils 107 of the rotor 101 and thus prevents overheating of these coils having regard to the thermal inertia of the machine. This advantage allows optimisation of the retarder in its functioning during its different life cycles.

According to a variant embodiment of the invention, the magnetic coupling between the annular system 112 formed essentially by a ring made from a magnetic material, when the fan 109 is produced from a non-magnetic material, and the inducing rotor 101 can be replaced by a magnetic coupling between what can be called a reconstituted ring and the rotor 101. Such a reconstituted ring is obtained by folding the blades of the fan 109 so that the folded parts follow each other very closely and thus provide a fairly dense succession of metal elements that can be induced and cause the fan to rotate.

What is claimed is:

1. A disengageable arrangement of a fan in an electromagnetic retarder, the retarder comprising a rotating shaft, a rotor rotationally integral with the rotating shaft, induction coils disposed in a ring on the rotor, a generator with a rotor mounted on one end of the rotating shaft and supplying the induction coils, and a fan for circulating a gaseous cooling fluid on the induction coils, the arrangement wherein the fan is mounted so as to rotate freely on the rotating shaft and is provided with means forming an armature able to be exposed to an electromagnetic field generated by the induction coils and driving the fan in rotation.

2. The disengageable arrangement according to claim 1, wherein said means forming an armature comprise a ring made from a magnetizable material situated opposite the induction coils of the rotor.

3. The disengageable arrangement according to claim 2, wherein the ring forming an armature is produced from laminated metal sheets with conductors in short-circuit according to the principle of asynchronous machine cages.

4. The disengageable arrangement according to claim 1, wherein the fan is produced from a non-magnetic material.

5. The disengageable arrangement according to claim 1, wherein the ring forming an armature is produced in the form of a permanent magnet.

6. The disengageable arrangement according to claim 1, wherein the means forming an armature comprise blade parts conformed so as to pass in front of the induction coils so as to be able to be sufficiently induced by the magnetic field of the induction coils for the fan to be driven in rotation.

7. The disengageable arrangement according to claim 1, wherein the fan is produced from an electromagnetic material.

8. The disengageable arrangement according to claim 1, wherein the fan is mounted on the rotating shaft by means of a bearing.

9. The disengageable arrangement according to claim 1, wherein the fan is mounted on the rotating shaft by means of a sliding bearing.

10. The disengageable arrangement according to claim 1, wherein the fan is produced from plastics material with a low coefficient of friction compared with steel and is mounted on the rotating shaft without a bearing.

11. The disengageable arrangement according to claim 1, wherein the heads of the induction coils have a pole made from magnetic material passing through them.

12. An electromagnetic retarder comprising:
a rotating shaft with a fan for circulating a gaseous cooling fluid over induction coils intended to generate, on command, eddy currents in an armature surrounding the rotating shaft and the induction coils, which comprises an arrangement according to which the fan is mounted so as to rotate freely on the rotating shaft and is provided with means forming an armature able to be exposed to an electromagnetic field generated by the induction coils and driving the fan in rotation.

13. A retarder for use on a vehicle, the retarder comprising:
a rotating shaft having a rotor;
induction coils disposed in a ring on said rotor;
a generator with a generator rotor mounted on one end of said rotating shaft and said induction coils; and
a generator fan for circulating a cooling fluid on the induction coils;
said generator fan being mounted so as to rotate freely on the rotating shaft and comprising an armature for driving said fan in response to an electromagnetic field generated by said induction coils.

14. The retarder according to claim 13, wherein said armature comprises a ring made from a magnetizable material situated opposite the induction coils of the rotor.

15. The retarder according to claim 14, wherein said ring forming an armature is produced from laminated metal sheets with conductors in short-circuit according to the principle of asynchronous machine cages.

16. The retarder according to claim 13, wherein said fan is produced from a non-magnetic material.

17. The retarder according to claim 13, wherein said armature is produced in the form of a permanent magnet.

18. The retarder according to claim 13, wherein said armature comprises blade parts conformed so as to pass in front of the induction coils so as to be able to be sufficiently induced by the magnetic field of the induction coils for the fan to be driven in rotation.

19. The retarder according to claim 13, wherein the fan is produced from an electromagnetic material.

20. The arrangement according to claim 13, wherein the fan is mounted on the rotating shaft by means of a bearing.
